(19) United States
(12) Patent Application Publication
(10) Pub. No.: US 2026/0018844 A1
(43) Pub. Date: Jan. 15, 2026

(54) Twisted Pair Cable Crimping System and Twisted Pair Cable Crimping Method

(71) Applicant: Tyco Electronics (Shanghai) Co., Ltd., Shanghai (CN)

(72) Inventors: Baisong (Ethan) Zhou, Suzhou (CN); Jianguo (Thomas) Yang, Shanghai (CN); Chaolei Liu, Suzhou (CN); Chunlong Li, Shanghai (CN)

(73) Assignee: Tyco Electronics (Shanghai) Co., Ltd., Shanghai (CN)

(21) Appl. No.: 19/265,042

(22) Filed: Jul. 10, 2025

(30) Foreign Application Priority Data
Jul. 10, 2024 (CN) 202410925041.5

(51) Int. Cl. H01R 43/052; G06T 7/00; G06T 7/13; G06T 7/60; G06T 7/73; G06V 10/70

(52) U.S. Cl. CPC H01R 43/052; G06T 7/001; G06T 7/13; G06T 7/60; G06T 7/74; G06V 10/70; G06T 2207/30108; G06T 2207/30172; G06T 2207/30242; G06V 2201/06

(57) ABSTRACT

A twisted pair cable crimping system includes a cable fixture clamping and fixing a twisted pair cable, a moving device moving the cable fixture, and an artificial intelligence vision device installed at a detection station to recognize an actual position of a pair of geometric centers of a pair of conductor cores of the twisted pair cable and an actual distance between the geometric centers. The crimping system includes a position calibration device calibrating a crimping position of the twisted pair cable based on a position deviation between an actual position and a predetermined ideal position where the actual distance is not less than a predetermined safe distance. A crimping device installed at a crimping station crimps a conductor core onto a terminal fixed at a predetermined crimping position. The geometric center of the conductor core is located on a centerline of the terminal fixed at the predetermined crimping position.

### CROSS-REFERENCE TO RELATED APPLICATIONS

This application claims the benefit of the filing date under 35 U.S.C. § 119 (a)-(d) of Chinese Patent Application No. 202410925041.5, filed on Jul. 10, 2024.

### FIELD OF THE INVENTION

The present invention relates to a twisted pair cable crimping system and a twisted pair cable crimping method.

### BACKGROUND

In order to crimp the core wire of the twisted pair cable to the terminal, it is necessary to first peel off a section of the outer covering layer on the twisted pair cable to expose two core wires, then unwind and straighten the two exposed core wires, and finally peel off a section of the outer insulation layer on the two core wires to expose the conductor cores. The conductor core of twisted pair cable usually includes multiple fine conductive wires twisted together, such as multiple fine copper wires twisted together.

Due to errors in the processing of twisted pair cable, it is difficult for the conductor core of the twisted pair cable to be in the predetermined ideal position. There is a certain positional deviation between its actual position and the predetermined ideal position, which can result in the conductor core not being accurately positioned at the predetermined crimping position. In the prior art, the guiding structure of the crimping device is usually used to guide the conductor core to the correct crimping position. However, the guiding structure cannot reliably guide the conductor core to the correct crimping position, which leads to unstable crimping quality.

In addition, due to the small diameter of the fine conductive wires in the conductor core of twisted pair cable, there is a risk of some fine conductive wires being cut or broken during the processing of twisted pair cable, which can result in the actual number of fine conductive wires in the conductor core being less than the predetermined number. However, in the prior art, it is impossible to identify and determine the actual number of fine conductive wires in the conductor core, which will reduce the quality of twisted pair cable products.

### SUMMARY

A twisted pair cable crimping system includes a cable fixture clamping and fixing a twisted pair cable, a moving device moving the cable fixture, and an artificial intelligence vision device installed at a detection station to recognize an actual position of a pair of geometric centers of a pair of conductor cores of the twisted pair cable and an actual distance between the geometric centers. The crimping system includes a position calibration device calibrating a crimping position of the twisted pair cable based on a position deviation between an actual position and a predetermined ideal position where the actual distance is not less than a predetermined safe distance. A crimping device installed at a crimping station crimps a conductor core onto a terminal fixed at a predetermined crimping position. The geometric center of the conductor core is located on a centerline of the terminal fixed at the predetermined crimping position.

### BRIEF DESCRIPTION OF THE DRAWINGS

Features of the invention will become apparent upon consideration of the following detailed disclosure of the invention, especially when taken in conjunction with the accompanying drawings wherein:

FIG. 1 shows an illustrative perspective view of a processed twisted pair cable according to an exemplary embodiment of the present invention;

FIG. 2 shows an illustrative perspective view of a twisted pair cable crimping system according to an exemplary embodiment of the present invention;

FIG. 3 shows a schematic sectional plan view of a crimping device of a twisted pair cable crimping system according to an exemplary embodiment of the present invention;

FIG. 4 shows an schematic plan view of a twisted pair cable crimping system according to an exemplary embodiment of the present invention, in which an ideal twisted pair cable without positional deviation is displayed and the twisted pair cable is at a detection station;

FIG. 5 shows a schematic plan view of a twisted pair cable crimping system according to an exemplary embodiment of the present invention, in which an actual produced twisted pair cable with positional deviation is displayed and the twisted pair cable is at a detection station;

FIG. 6 shows a schematic plan view of a twisted pair cable crimping system according to an exemplary embodiment of the present invention, wherein a movable mold of the crimping device simultaneously covers two conductor cores of the twisted pair cable;

FIG. 7 shows a schematic plan view of a twisted pair cable crimping system according to an exemplary embodiment of the present invention, wherein the movable mold of the crimping device only covers one conductor core of the twisted pair;

FIG. 8 shows an end view of a qualified twisted pair cable according to an exemplary embodiment of the present invention;

FIG. 9 shows a partially enlarged view of a qualified twisted pair conductor core according to an exemplary embodiment of the present invention; and

FIG. 10 shows an end view of an unqualified twisted pair cable according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

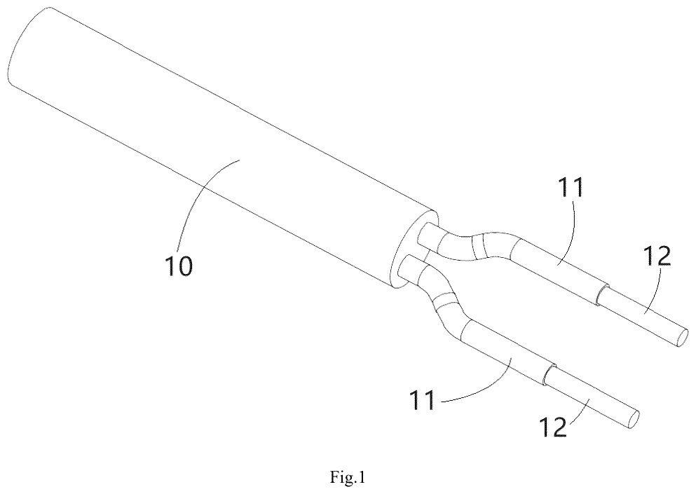

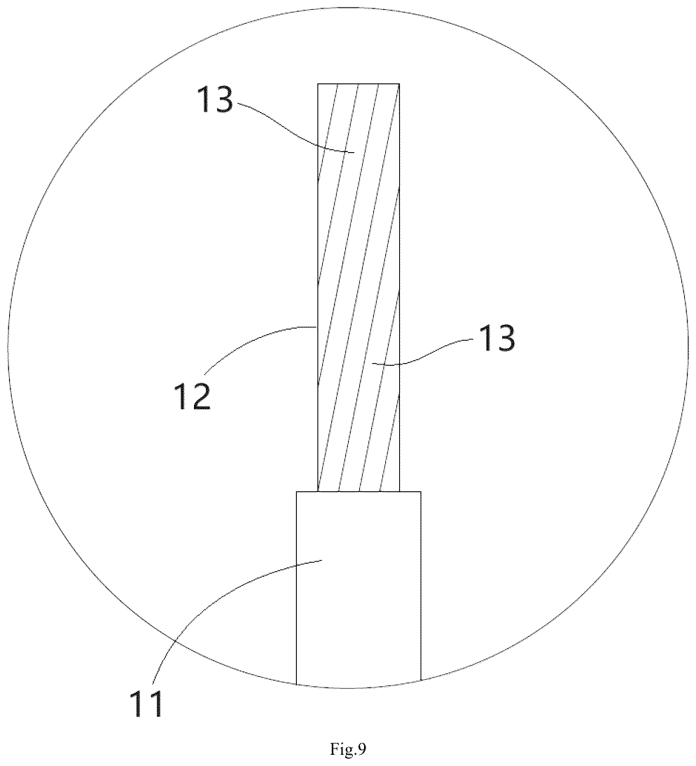

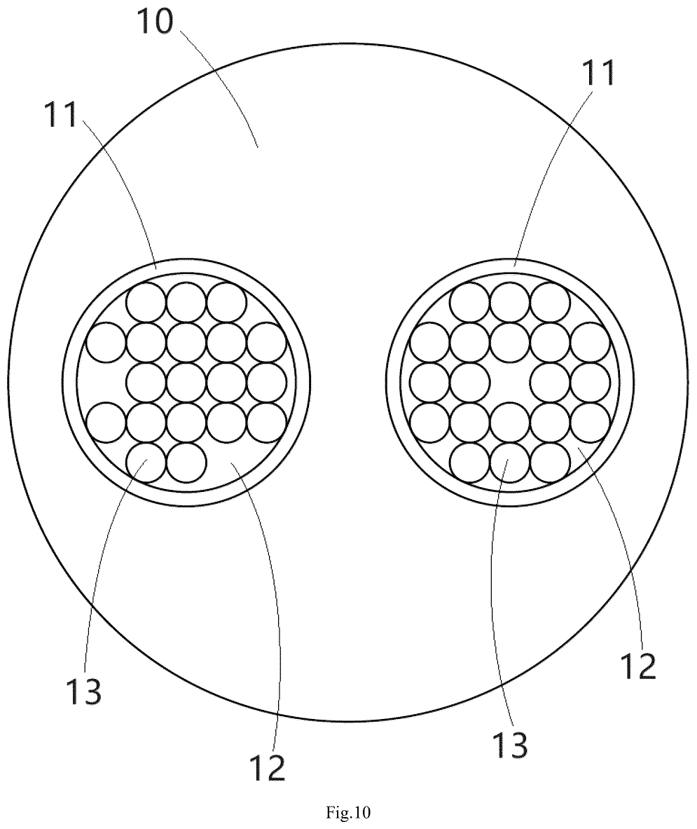

As shown in FIGS. 1 to 10, in an exemplary embodiment of the present invention, a twisted pair cable crimping system is disclosed. The twisted pair cable crimping system includes: a cable fixture 5, a moving device 6, an artificial intelligence vision device 3, a position calibration device, and a crimping device 4. The cable fixture 5 is used to clamp and fix the twisted pair cable 10. The moving device 6 is used to move the cable fixture 5 and the twisted pair cable 10 along the horizontal direction X perpendicular to the axial direction Y of twisted pair cable 10. The artificial intelligence vision device 3 is installed at the detection station, which can mimic the human eye to recognize the actual positions P1′, P2′ of the geometric centers of the two exposed conductor cores 12 of the twisted pair cable 10 moved to the detection station, and the actual distance between the geometric centers of the two conductor cores 12 in the horizontal direction X. The position calibration device is suitable for calibrating the crimping position of twisted pair cable 10 based on the positional deviation between the actual positions P1′, P2′ and the predetermined ideal positions P1, P2 in a condition where the actual distance is not less than the predetermined safe distance, in order to eliminate positional deviation. The crimping device 4 is set at the crimping station, used to crimp the conductor core 12 to the terminal 2 fixed at the predetermined crimping position. When the conductor core 12 is moved to the predetermined crimping position, the geometric center of the conductor core 12 is located on the centerline of the terminal 2 fixed at the predetermined crimping position.

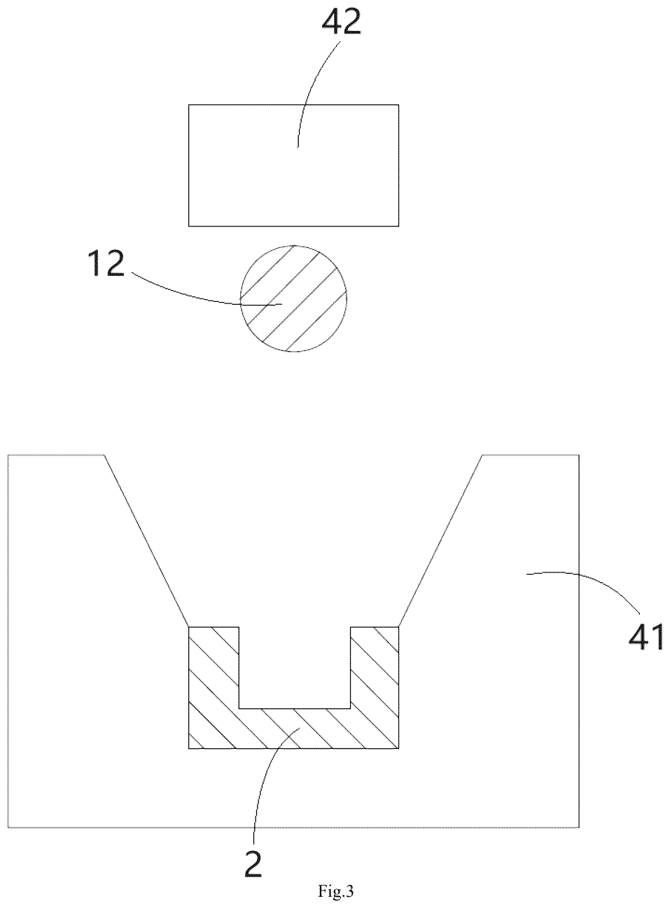

As shown in FIG. 3, in the illustrated embodiment, the crimping device 4 includes a fixed mold 41 and a movable mold 42. The fixed mold 41 is fixed at the predetermined crimping position, used to fix the terminal 2 and guide the conductor core 12 into the terminal 2. The movable mold 42 is located above the fixed mold 41 and can move in the vertical direction Z perpendicular to the axial direction Y of the twisted pair cable 10, used to press the terminal 2 onto the conductor core 12. In the illustrated embodiment, the predetermined safety distance is equal to half the width of the movable mold 42 in the horizontal direction X.

In an embodiment, the twisted pair cable crimping system further includes a position adjustment device, which is adapted to adjust the position of the conductor core 12 at the crimping station when the actual distance is less than the predetermined safe distance, in order to prevent the two conductor cores 12 of the twisted pair cable 10 from being simultaneously crimped to the same terminal 2 by the movable mold 42.

When the actual distance is less than the predetermined safe distance, the position adjustment device adjusts the position of the two conductor cores 12 of the twisted pair cable 10 relative to the movable mold 42, so that the currently crimped conductor core 12 is located in the coverage area of the movable mold 42 in the vertical direction Z, and the other conductor core 12 is located outside the coverage area of the movable mold 42 and close to the side edge of the coverage area.

In an embodiment, the artificial intelligence vision device 3 includes a recognition module and a calculation module. The recognition module can mimic the human eye to recognize the geometric contours of the exposed core wire 11 and the exposed conductor core 12 of the twisted pair cable 10. The calculation module can calculate the actual position P1′, P2′ of the geometric center of the conductor core 12 based on the recognized geometric contour of the conductor core 12, the positional deviation between the actual positions P1′, P2′ and to the predetermined ideal positions P1, P2, as well as the actual distance between the geometric centers of the two conductor cores 12.

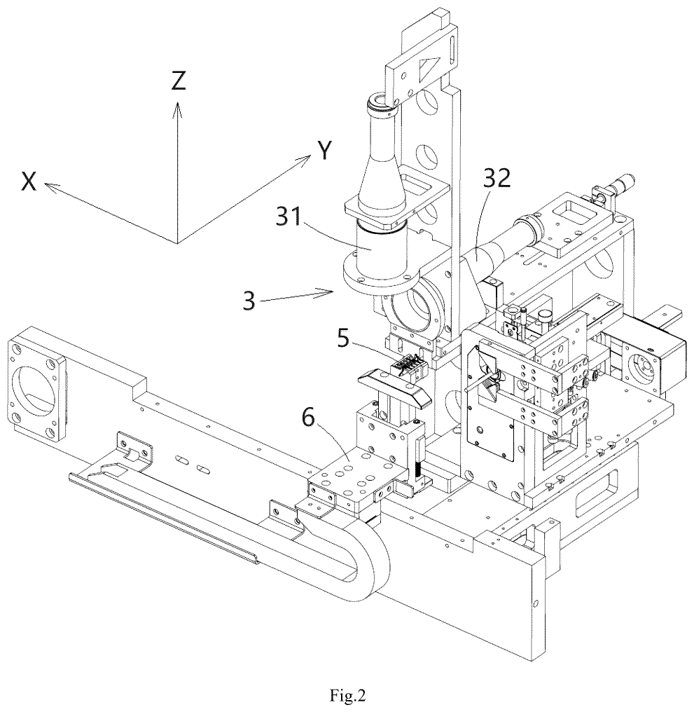

As shown in FIG. 2, in the illustrated embodiment, the recognition module includes a vertical camera 31 and a visual processor. The vertical camera 31 is used to capture images of the twisted pair cable 10 along the vertical direction Z perpendicular to the axial direction Y of the twisted pair cable 10. The visual processor can recognize the geometric contours of the core wire 11 and conductor core 12 of the twisted pair cable 10 based on the image captured by the vertical camera 31.

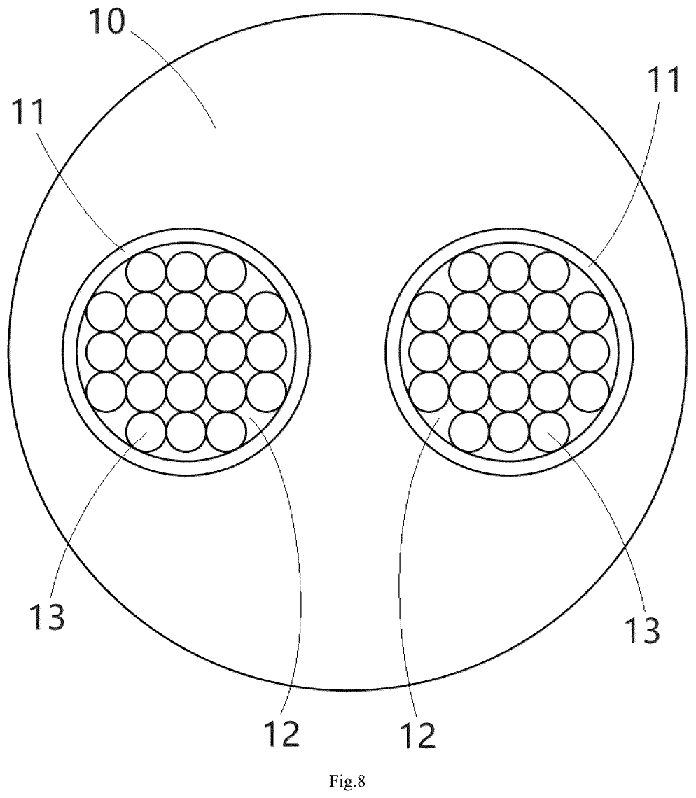

As shown in FIG. 8, in the illustrated embodiment, each conductor core 12 of the twisted pair cable 10 includes multiple fine conductive wires 13 twisted together. The artificial intelligence vision device 3 can also mimic the human eye to recognize the actual number of fine conductive wires 13 in each conductor core 12 of the twisted pair cable 10. When the actual number of fine conductive wires 13 in the conductor core 12 recognized by the artificial intelligence vision device 3 is not equal to the predetermined number, the artificial intelligence vision device 3 determines that the quality of the twisted pair cable 10 is unqualified.

In an embodiment, the twisted pair cable crimping system further includes a removal device, which is set at the detection station for removing the unqualified twisted pair cable 10 from the cable fixture 5.

In an embodiment, the artificial intelligence vision device 3 includes a recognition module and a calculation module. The recognition module can mimic the human eye to recognize the end face profiles of the two core wires 11 of the twisted pair cable 10 and the end face profiles of the fine conductive wires 13 of the two conductor cores 12. The calculation module can calculate the actual number of fine conductive wires 13 in the conductor core 12 based on the recognized end face profiles of the core wires 11 and the end face profiles of the fine conductive wires 13 in the conductor cores 12.

The recognition module includes a horizontal camera 32, shown in FIG. 2, and a visual processor. The horizontal camera 32 is used to capture the end face image of the twisted pair cable 10 along the axial direction Y of the twisted pair cable 10. The visual processor can recognize the end face profiles of the two core wires 11 of the twisted pair cable 10 and the end face profiles of the fine conductive wires 13 of the two conductor cores 12 based on the end face image of the twisted pair cable 10 captured by the horizontal camera 32.

In an exemplary embodiment of the present invention, a twisted pair cable crimping system is disclosed. The twisted pair cable crimping system includes: a cable fixture 5, a moving device 6, and an artificial intelligence vision device 3. The cable fixture 5 is used to clamp and fix the twisted pair cable 10, each conductor core 12 of twisted pair cable 10 includes multiple fine conductive wires 13 twisted together. The moving device 6 is used to move the cable fixture 5 and the twisted pair cable 10 along the horizontal direction X perpendicular to the axial direction Y of twisted pair cable 10. The artificial intelligence vision device 3 is installed at the detection station and can mimic the human eye to recognize the actual number of fine conductive wires 13 in each conductor core 12 of the twisted pair cable 10. When the actual number of fine conductive wires 13 in the conductor core 12 recognized by the artificial intelligence vision device 3 is not equal to the predetermined number, the artificial intelligence vision device 3 determines that the quality of the twisted pair cable 10 is unqualified.

In an embodiment, the twisted pair cable crimping system further includes a removal device, which is set at the detection station for removing the unqualified twisted pair cable 10 from the cable fixture 5.

In an embodiment, the artificial intelligence vision device 3 includes a recognition module and a calculation module. The recognition module can mimic the human eye to recognize the end face profiles of the two core wires 11 of the twisted pair cable 10 and the end face profiles of the fine conductive wires 13 of the two conductor cores 12. The calculation module can calculate the actual number of fine conductive wires 13 in the conductor core 12 based on the recognized end face profiles of the core wires 11 and the end face profiles of the fine conductive wires 13 in the conductor cores 12.

As shown in FIGS. 1 to 10, in the illustrated embodiment, the recognition module includes a horizontal camera 32 and a visual processor. The horizontal camera 32 is used to capture the end face image of the twisted pair cable 10 along the axial direction Y of the twisted pair cable 10. The visual processor can recognize the end face profiles of the two core wires 11 of the twisted pair cable 10 and the end face profiles of the fine conductive wires 13 of the two conductor cores 12 based on the end face image of the twisted pair cable 10 captured by the horizontal camera 32.

The artificial intelligence vision device 3 can also mimic the human eye to recognize the actual positions P1′, P2′ of the geometric centers of the two exposed conductor cores 12 of the twisted pair cable 10 moved to the detection station, as well as the actual distance between the geometric centers of the two conductor cores 12 in the horizontal direction X. The twisted pair cable crimping system also includes a position calibration device and a crimping device 4. The position calibration device is suitable for calibrating the crimping position of twisted pair cable 10 based on the positional deviation between the actual positions P1′, P2′ and the predetermined ideal positions P1, P2 in a condition where the actual distance is not less than the predetermined safe distance, in order to eliminate positional deviation. The crimping device 4 is set at the crimping station, used to crimp the conductor core 12 to the terminal 2 fixed at the predetermined crimping position. When the conductor core 12 is moved to the predetermined crimping position, the geometric center of the conductor core 12 is located on the centerline of the terminal 2 fixed at the predetermined crimping position.

As shown in FIG. 3, in the illustrated embodiment, the crimping device 4 includes a fixed mold 41 and a movable mold 42. The fixed mold 41 is fixed at the predetermined crimping position, used to fix the terminal 2 and guide the conductor core 12 into the terminal 2. The movable mold 42 is located above the fixed mold 41 and can move in the vertical direction Z perpendicular to the axial direction Y of the twisted pair cable 10, used to press the terminal 2 onto the conductor core 12. The predetermined safety distance is equal to half the width of the movable mold 42 in the horizontal direction X.

In an embodiment, the twisted pair cable crimping system further includes a position adjustment device, which is suitable for adjusting the position of the conductor core 12 at the crimping station when the actual distance is less than the predetermined safe distance, to prevent the two conductor cores 12 of the twisted pair cable 10 from being simultaneously crimped to the same terminal 2 by the movable mold 42.

When the actual distance is less than the predetermined safe distance, the position adjustment device adjusts the position of the two conductor cores 12 of the twisted pair cable 10 relative to the movable mold 42, so that the currently crimped conductor core 12 is located in the coverage area of the movable mold 42 in the vertical direction Z, and the other conductor core 12 is located outside the coverage area of the movable mold 42 and close to the side edge of the coverage area.

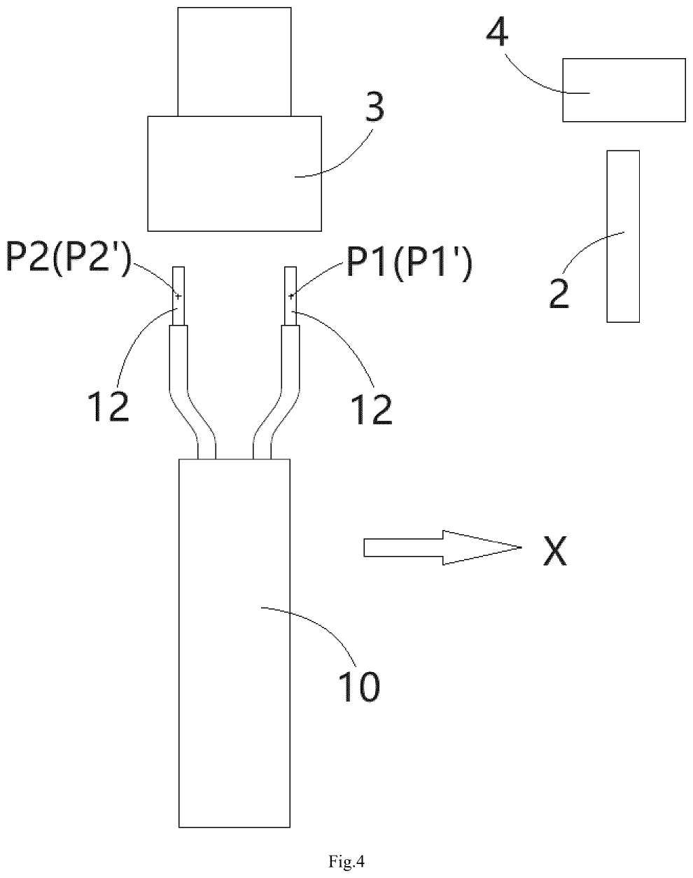

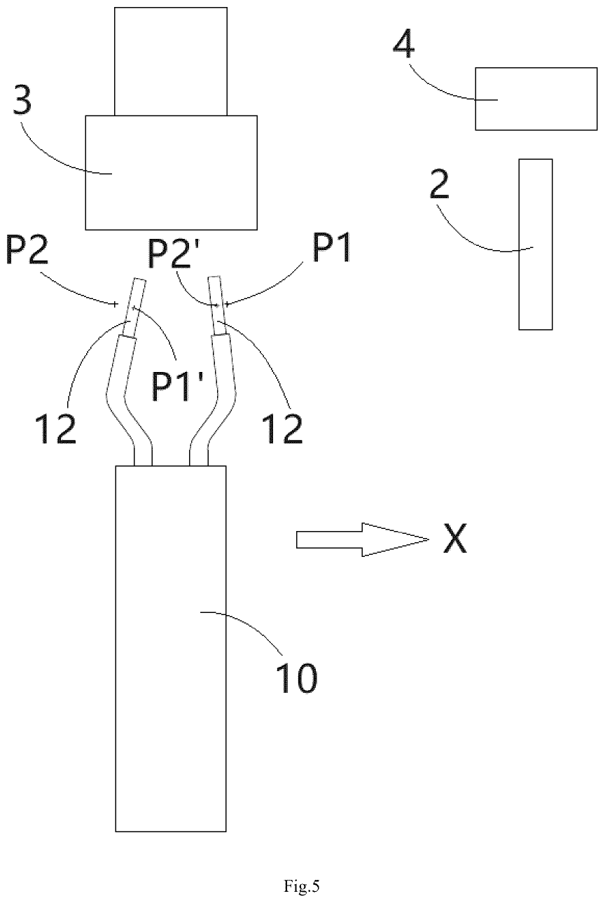

In an embodiment, the artificial intelligence vision device 3 includes a recognition module and a calculation module. The recognition module can mimic the human eye to recognize the geometric contours of the exposed core wire 11 and the exposed conductor core 12 of the twisted pair cable 10. The calculation module can calculate the actual position P1′, P2′ of the geometric center of the conductor core 12 based on the recognized geometric contour of the conductor core 12, the positional deviation between the actual positions P1′, P2′ and the predetermined ideal positions P1, P2, as well as the actual distance between the geometric centers of the two conductor cores 12, shown in FIGS. 4 and 5.

As shown in FIG. 2, in the illustrated embodiment, the recognition module includes a vertical camera 31 and a visual processor. The vertical camera 31 is used to capture images of the twisted pair cable 10 along the vertical direction Z perpendicular to the axial direction Y of the twisted pair cable 10. The visual processor recognizes the geometric contours of the core wire 11 and conductor core 12 of the twisted pair cable 10 based on the image captured by the vertical camera 31.

In another exemplary embodiment of the present invention, there is also disclosed a twisted pair cable crimping method. The twisted pair cable crimping method includes the following steps:
S10: providing the aforementioned twisted pair cable crimping system.
S20: fixing the twisted pair cable 10 to be crimped onto the cable fixture 5 and using the moving device 6 to move the twisted pair cable 10 fixed onto the cable fixture 5 to the detection station.
S30: using the artificial intelligence vision device 3 to identify the actual number of fine conductive wires 13 in each conductor core 12 of twisted pair cable 10.
S40: determining whether the quality of twisted pair cable 10 is qualified based on the actual number of fine conductive wires 13 in the identified conductor core 12.

If the judgment result of step S40 is no, the following steps are executed:
S50: removing the unqualified twisted pair cable 10 from cable fixture 5 by the removal device.
S51: using the moving device 6 to move the cable fixture 5 to a loading station for loading the twisted pair cable 10.
S52: returning to the previous step S20.

If the judgment result of step S40 is yes, the following steps are executed:
S60: using the artificial intelligence vision device 3 to identify the actual positions P1′, P2′ of the geometric centers of the two conductor cores 12 of twisted pair cable 10, as well as the actual distance between the geometric centers of the two conductor cores 12 in the horizontal direction X perpendicular to the axial direction Y of twisted pair cable 10, as shown in FIGS. 4 and 5.
S70: determining whether the actual distance is not less than the predetermined safe distance.

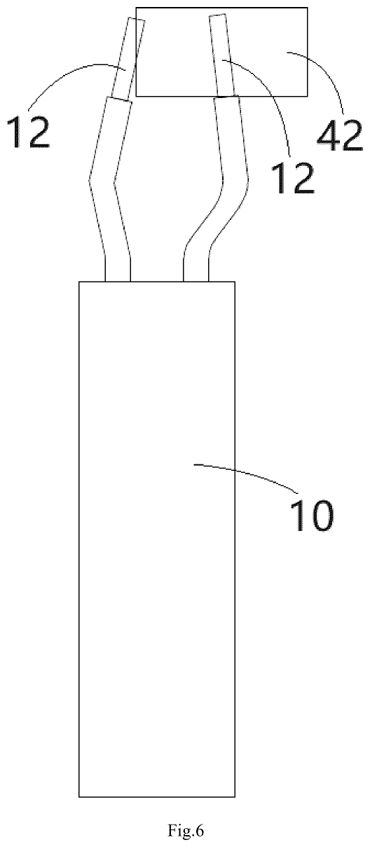

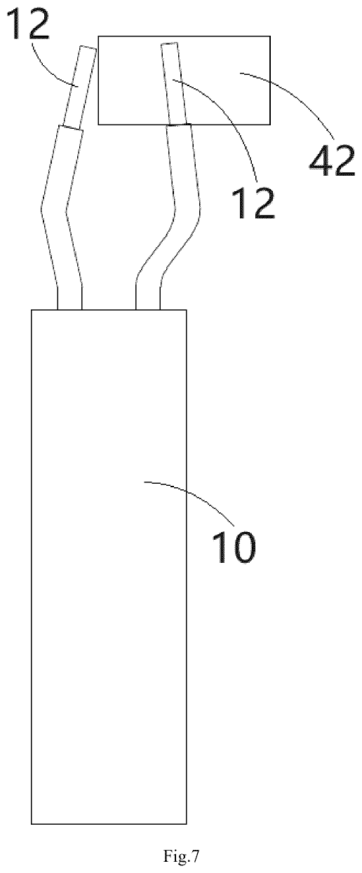

If the judgment result of step S70 is no, the following steps are executed:
S80: using the moving device 6 to move the twisted pair cable 10 along the horizontal direction X to the crimping station and adjusting the position of the conductor core 12 by the position adjustment device to prevent the two conductor cores 12 of the twisted pair cable 10 from being simultaneously crimped to the same terminal 2 by the movable mold 42 of the crimping device 4, as shown in FIGS. 6 and 7.
S81: using the crimping device 4 to crimp the conductor core 12 onto the terminal 2 fixed at the predetermined crimping position.
S82: using the moving device 6 to move the twisted pair cable 10 with terminal 2 that has been crimped to the detection station, and using the artificial intelligence vision device 3 to check whether the crimping quality of twisted pair cable 10 is qualified, as shown in FIGS. 8-10.
S83: using the moving device 6 to move the twisted pair cable 10 to an unloading station and unloading the twisted pair cable 10 with qualified crimping quality to a qualified product recycling box or unloading the twisted pair cable 10 with unqualified crimping quality to an unqualified product recycling box.
S84: using the moving device 6 to move the cable fixture 5 to a loading station for loading the twisted pair cable 10.
S85: returning to the previous step S20.

If the judgment result of step S70 is yes, the following steps are executed:
S90: using the moving device 6 to move the twisted pair cable 10 along the horizontal direction X to the crimping station and using the position calibration device to calibrate the crimping position of the conductor core 12, so that the geometric center of the conductor core 12 is located on the centerline of the terminal 2 fixed at the predetermined crimping position.
S91: using the crimping device 4 to crimp the conductor core 12 onto the terminal 2 fixed at the predetermined crimping position.
S92: using the moving device 6 to move the twisted pair cable 10 with terminal 2 that has been crimped to the detection station, and using the artificial intelligence vision device 3 to check whether the crimping quality of twisted pair cable 10 is qualified.
S93: using the moving device 6 to move the twisted pair cable 10 to an unloading station and unloading the twisted pair cable 10 with qualified crimping quality to a qualified product recycling box or unloading the twisted pair cable 10 with unqualified crimping quality to an unqualified product recycling box.
S94: e moving device 6 to move the cable fixture 5 to a loading station for loading the twisted pair cable 10.
S95: returning to the previous step S20.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A twisted pair cable crimping system, comprising:
a cable fixture clamping and fixing a twisted pair cable;
a moving device moving the cable fixture and the twisted pair cable in a horizontal direction perpendicular to an axial direction of the twisted pair cable;
an artificial intelligence vision device installed at a detection station to recognize an actual position of a pair of geometric centers of a pair of conductor cores of the twisted pair cable moved to the detection station and an actual distance between the pair of geometric centers of the pair of conductor cores in the horizontal direction;
a position calibration device calibrating a crimping position of the twisted pair cable based on a position deviation between an actual position and a predetermined ideal position in a condition where the actual distance is not less than a predetermined safe distance; and
a crimping device installed at a crimping station for crimping a conductor core of the pair of conductor cores onto a terminal fixed at a predetermined crimping position, the conductor core is moved to the predetermined crimping position, the geometric center of the conductor core is located on a centerline of the terminal fixed at the predetermined crimping position.

2. The twisted pair cable crimping system of claim 1, wherein the crimping device includes a fixed mold which is fixed at the predetermined crimping position for fixing the terminal and guiding the conductor core into the terminal.

3. The twisted pair cable crimping system of claim 2, wherein the crimping device includes a movable mold located above the fixed mold, the movable mold is movable in a vertical direction perpendicular to the axial direction of the twisted pair cable, for crimping the terminal onto the conductor core, the predetermined safe distance is equal to half a width of the movable mold in the horizontal direction.

4. The twisted pair cable crimping system of claim 3, further comprising a position adjustment device adjusting a position of the conductor core at the crimping station when the actual distance is less than the predetermined safe distance, to prevent each conductor core of the twisted pair cable from being simultaneously crimped into the terminal by the movable mold.

5. The twisted pair cable crimping system of claim 4, wherein, when the actual distance is less than the predetermined safe distance, the position adjustment device adjusts the position of each conductor core of the twisted pair cable relative to the movable mold, so that a currently crimped conductor core is located in an coverage area of the movable mold in the vertical direction, and a secondary conductor core is located outside the coverage area of the movable mold.

6. The twisted pair cable crimping system of claim 1, wherein the artificial intelligence vision device includes a recognition module to recognize a geometric contour of a core wire and a geometric contour of the conductor core of the twisted pair cable.

7. The twisted pair cable crimping system of claim 6, wherein the artificial intelligence vision device includes a calculation module that calculates the actual position of the geometric center of the conductor core based on the geometric contour, a positional deviation between the actual position and the predetermined ideal position, and the actual distance between the geometric centers of the pair of conductor cores.

8. The twisted pair cable crimping system of claim 7, wherein the recognition module includes a vertical camera capturing an image of the twisted pair cable along a vertical direction perpendicular to the axial direction of the twisted pair cable.

9. The twisted pair cable crimping system of claim 8, wherein the recognition module further includes a visual processor that recognizes the geometric contour of the core wire and the conductor core of the twisted pair cable based on the image captured by the vertical camera.

10. The twisted pair cable crimping system of claim 1, wherein each conductor core of the twisted pair cable has a plurality of fine conductive wires twisted together, the artificial intelligence vision device can recognize an actual number of fine conductive wires in each conductor core of the twisted pair cable.

11. The twisted pair cable crimping system of claim 10, wherein, if the actual number of fine conductive wires of the conductor core recognized by the artificial intelligence vision device is not equal to a predetermined number, the artificial intelligence vision device determines that a quality of the twisted pair cable is unqualified.

12. The twisted pair cable crimping system of claim 11, further comprising a removal device at the detection station that removes an unqualified twisted pair cable from the cable fixture.

13. The twisted pair cable crimping system of claim 11, wherein the artificial intelligence vision device includes a recognition module to recognize an end face profile of each core wire of a pair of core wires of the twisted pair cable and an end face profile of each of the plurality of fine conductive wires of each conductor core.

14. The twisted pair cable crimping system of claim 13, wherein the artificial intelligence vision device includes a calculation module calculating the actual number of fine conductive wires in the conductor core based on a recognized end face profile of each core wire and the end face profiles of the fine conductive wires in the conductor core.

15. The twisted pair cable crimping system of claim 14, wherein the recognition module includes a horizontal camera capturing an end face image of the twisted pair cable along the axial direction of the twisted pair cable and a visual processor recognizing the end face profile of each of the core wires of the twisted pair cable and the end face profiles of the fine conductive wires of each conductor core based on the end face image of the twisted pair cable captured by the horizontal camera.

16. A method of a twisted pair cable crimping system, comprising:
providing a twisted pair cable crimping system;
fixing a twisted pair cable to be crimped onto a cable fixture and using a moving device to move the twisted pair cable fixed onto the cable fixture to a detection station;
using an artificial intelligence vision device to identify an actual number of fine conductive wires in each conductor core of a pair of conductor cores of the twisted pair cable; and
determining whether a quality of the twisted pair cable is qualified based on a identified actual number of fine conductive wires of at least one of the conductor cores.

17. The method of the twisted pair cable crimping system of claim 16, wherein, if a judgment result of determining whether the quality of the twisted pair cable is qualified based on the identified actual number of fine conductive wires of the conductor core is no, the following steps are executed:
using a removal device to remove an unqualified twisted pair cable from the cable fixture;
using the moving device to move the cable fixture to a loading station for loading the twisted pair cable; and
returning to fixing the twisted pair cable to be crimped onto the cable fixture and using the moving device to move the twisted pair cable fixed onto the cable fixture to the detection station.

18. The method of the twisted pair cable crimping system of claim 16, wherein, if a judgment result of determining whether the quality of the twisted pair cable is qualified based on the identified actual number of fine conductive wires of the conductor core is yes, the following steps are executed:
using the artificial intelligence vision device to identify a actual positioning of a geometric center of each conductor core of the twisted pair cable and an actual distance between the geometric center of each conductor core in a horizontal direction perpendicular to an axial direction of the twisted pair cable; and
determining whether the actual distance is not less than a predetermined safe distance.

19. The method of the twisted pair cable crimping system claim 18, wherein if a judgment result of determining whether the actual distance is not less than the predetermined safe distance is no, the following steps are executed:
using the moving device to move the twisted pair cable along the horizontal direction to the crimping station and adjusting a position of the conductor core using a position adjustment device to prevent the conductor cores of the twisted pair cable from being simultaneously crimped into a terminal by a movable mold of the crimping device;
using the crimping device to crimp one of the conductor cores onto the terminal fixed at a predetermined crimping position;
using the moving device to move the twisted pair cable with the terminal already crimped to the detection station, and using the artificial intelligence vision device to detect whether a crimping quality of the twisted pair cable is qualified;
using the moving device to move the twisted pair cable to an unloading station and unloading the twisted pair cable with qualified crimping quality to a qualified product recycling box or unloading the twisted pair cable with unqualified crimping quality to an unqualified product recycling box;
using the moving device to move the cable fixture to a loading station for loading the twisted pair cable; and
returning to fixing the twisted pair cable to be crimped onto the cable fixture and using the moving device to move the twisted pair cable fixed onto the cable fixture to the detection station.

20. The method of the twisted pair cable crimping system of claim 18, wherein if a judgment result of determining whether the actual distance is not less than the predetermined safe distance is yes, the following steps are executed:
using the moving device to move the twisted pair cable along the horizontal direction to the crimping station and using a position calibration device to calibrate a crimping position of the conductor core, so that the geometric center of the conductor core is located on a centerline of the terminal fixed at a predetermined crimping position;
using the crimping device to crimp the conductor core onto a terminal fixed at the predetermined crimping position;
using the moving device to move the twisted pair cable with the terminal already crimped to the detection station, and using the artificial intelligence vision device to detect whether a crimping quality of the twisted pair cable is qualified;
using the moving device to move the twisted pair cable to an unloading station and unloading the twisted pair cable with qualified crimping quality to a qualified product recycling box or unloading the twisted pair cable with unqualified crimping quality to an unqualified product recycling box;
using the moving device to move the cable fixture to a loading station for loading the twisted pair cable; and
returning to fixing the twisted pair cable to be crimped onto the cable fixture and using the moving device to move the twisted pair cable fixed onto the cable fixture to the detection station.
